(19) United States
(12) Patent Application Publication
(10) Pub. No.: US 2011/0223023 A1
(43) Pub. Date: Sep. 15, 2011

(54) Mechanical rotor

(76) Inventor: Melvin Don Carden, Amarillo, TX (US)

(21) Appl. No.: 12/661,096

(22) Filed: Mar. 11, 2010

(51) Int. Cl. F03D 3/06

(52) U.S. Cl. 416/117

(57) ABSTRACT

The Mechanical Rotor is a simple unique invention that salvages torque energy from excess linear kinetic energy produced by flowing rivers, streams, ocean currents, or blowing wind. The unique design of the invention salvages torque by the drag principal of Physics during part of a rotation. Rotation completion limits exposure to only a small aerodynamic surface into the pressure of the linear kinetic force.

The invention can be elongated, stacked, or clustered, and scalable, to accommodate any engineering design desired for using the salvaged torque to pump liquids, compress pneumatics, or generate electricity or any other useful purposes.

### CROSS-REFERENCE TO RELATED APPLICATIONS

U.S. PO Application No. 61/189,611, Originally Filed Aug. 21, 2008

### STATEMENT REGARDING FEDERAL SPONSORED RESEARCH

Not Applicable.

### REFERENCE TO SEQUENCE LISTING

Not Applicable.

### BACKGROUND OF THE INVENTION

Applicable known U.S. Patent Classification is 416/119; 415/202

International Classification FO3D March 2006 (20060101); FO3B January 2002 (20060101)

Searching Classifications 416, 415, 290, 244 developed the following Patent Table:

U.S. Pat. No. 54,123, Water Wheel, of D. Cushman, issued Apr. 21, 1866

U.S. Pat. No. 232,205, Wind Wheel J.C. Preston; Sep. 14, 1880

U.S. Pat. No. 285,584, Turbine for Stream, de Laval, Sep. 25, 1883

U.S. Pat. No. 1,111,350, Currant Motor, E. S. Bayley, May 12, 1913

U.S. Pat. No. 2,038,467, Vertical axis wind engine, L Zanoski Apr. 21, 1936

U.S. Pat. No. 3,442,492, Fluid Current Motor, E G Sullivan, May 6, 1969

U.S. Pat. No. 4,325,674, Cross_flow Olle Ljungstrom, Oct. 5, 1979.

U.S. Pat. No. 4,329,115, Directional stabilized wind turbine R. Kress etal May 11, 1982

U.S. Pat. No. 4,449,053, Vertical axis wind turbine, H. R. Kutcher May 15, 1984

U.S. Pat. No. 4,950,130, Pelton Turbine, Josef Erlach, Aug. 21, 1990

U.S. Pat. No. 6,755,607, Hydro energy converter, Hester, et al., Jun. 29, 2004.

U.S. Pat. No. 6,688,842, Windmill, Bruce E. Boatner; Feb. 10, 2004

U.S. Pat. No. 6,926,491, Vertical axis wind turbine, Bernard Migler, Aug. 9, 2005

U.S. Pat. No. 7,258,527, Vertical axis wind engine, S. C._Kuang; Filed Dec. 28, 2004

### BRIEF SUMMARY OF THE INVENTION

The invention is a simple unique device, similar to a water wheel designed to gather usable torque energy from the excess linear kinetic force existing at natural moving substances such as flowing rivers, streams, tides, or ocean currents, etc., without constructing dams or special flow directing canals. The invention, as a vertical axis device, can gather torque energy from the linear kinetic force of blowing wind.

### BACKGROUND OF THE INVENTION

The original Mechanical Rotor invention U.S. PO Application No. 61/189,611, filed Aug. 21, 2008 is amended by this submittal. The original concept design remains the same

Prior to the industrial revolution, the waterwheel was mankind's only means of harvesting and utilizing large quantities of energy. The waterwheel led to the development of the first practical windmill in about 50 AD. Each important in their own right, the waterwheel and the windmill have paved the way for the modern industrial turbine.

Many devices suitable for gathering torque from wind are impractical or structurally unsound when encountering the force of flowing water. Many are overly complicated, using special spring recoil action and other such devices. Most become large and cumbersome when considered for commercial applications and few are of suitable scale for a small mountain Trout stream.

### BRIEF DESCRIPTION OF THE DRAWINGS

FIG. 1. A tilted Isometric cut-away view of a four Foil invention.

FIG. 2. An overlay of Foil positions of invention during rotation partially submerged.

FIG. 3. An overlay of Foil positions of invention during rotation totally submerged.

FIG. 4. Section Plan view of 360 degree energy open four Foil invention design.

FIG. 5. Section Axial view of 360 degree open cage of a four Foil invention design.

FIG. 6. Section Plan view of rectangular duct guided energy to four Foil invention design.

FIG. 7. Axial section view of rectangular duct guided energy to four Foil invention design.

FIG. 8. Sketch of a stream anchored raft mounted with the invention.

FIG. 9. Sketch of a tidal tower mounted with the invention.

FIG. 10. Sketch tower mounted with invention.

FIG. 11. Sketch of residential house mounted with invention.

### DRAWING REFERENCE NUMERAL LIST TABLE

1. Linear Force 1
2. Wheel Plate 2
3. Power Shaft 3
4. Foil 4
4a Specific Foil 4a
4b Specific Foil 4b
4c Specific Foil 4c
4d Specific Foil 4d
5. Hinge Shaft 5
6. Support Tower 6
7. Thrust Bearing 7
8. Roller Bearing 8
9. Rectangular Duct 9
10. Duct Plate 10
10a. Duct Support 10a
10b. Duct Support 10b
11. Support apparatus 11
12. Torque Consumer 12
13. Frame Leg 13
14. Support Plate 14
15. Rotation Direction 15
15a. Foil Swing 15
16. Anchor Chain 16
17. Hinge Shaft Path 17
18. Vane Shroud 18
19. Anchor Guy 19
21. Foil Tip Path 21
22. Mechanical Rotor 22
23. Raft, Float, Barge, Ship, etc. 23
24. Flexible Umbilical Line 24
25. Umbilical Line 25
20. Structure Roof 20
26. Anchor 26
27. Flowing Water 27
28. Neap Tide 28
29. Ebb Tide 29

### DETAILED DESCRIPTION OF THE INVENTION

The following description illustrates the invented device as being functionally a waterwheel, rotating on a axis, harvesting torque energy from the positive drag force of flowing linear force of streams, rivers, ocean tides or wind. Adaptation of free swinging foils that self position according to the dynamic conditions to which they are subjected by the flowing linear force, creates a condition which develops a secondary method of extracting torque from flowing streams, rivers, ocean tides, or winds.

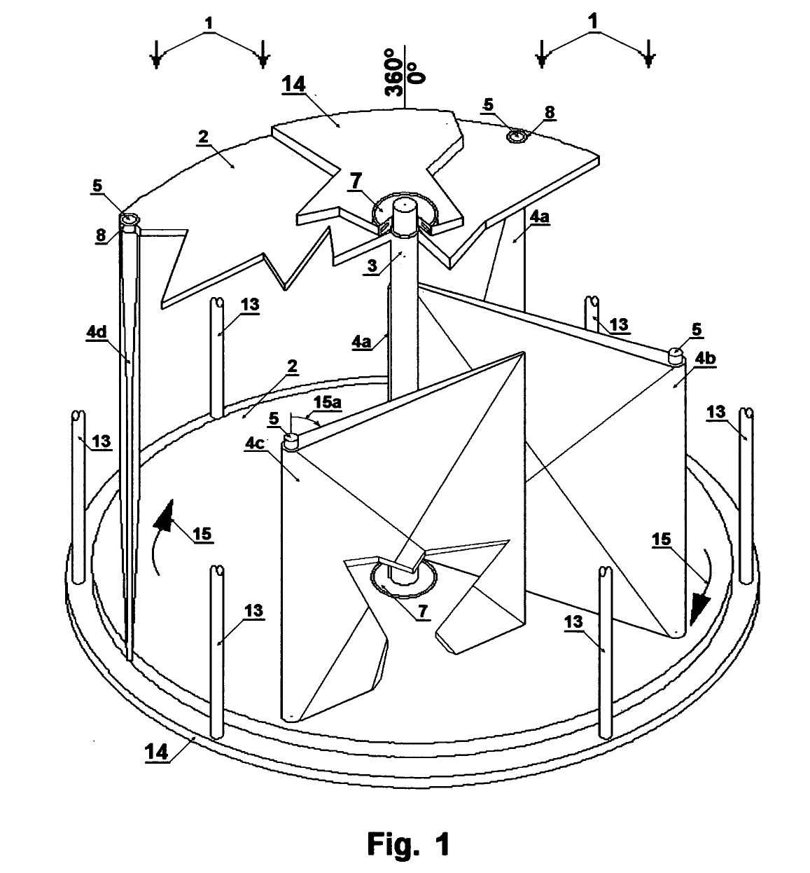

FIG. 1 displays a vertical axis arrangement of the invention showing an Isometric sketch of the essential features to the Mechanical Rotor exposed by cutaway segments within an open 360 degree cage forming a structural frame. The view is at a 22.5 degree point of rotation with 0 degree being directly into the Linear Force 1 pressure.

FIG. 1 view is applicable to a mirrored horizontal axis view or as either clockwise or counter clockwise Rotation Direction 15. As displayed by FIG. 1, the Mechanical Rotor invention is bi-directional, with rotation direction controlled by some device such as a hydraulic, pneumatic, electric, or mechanical device controlled by an independent operator.

FIG. 1 shows the Power Shaft 3 as the axel between two Wheel Plate 2's as a solid one piece unit. Each end of Power Shaft 3 extends through Thrust Bearing 7 affixed in Support Plate 14 to facilitate rotation and provides access as needed to Power Shaft 3 by any torque using Device re: pump, generator, pulley, gearing or other such device.

Symmetrically separating the Support Plate 14's are six Frame Leg 13's forming a structural cage which may be solidly mounted to some structure, such as a raft, tower, roof, etc. Three or more Frame Leg 13's are required, dependant upon the structural strength needed for a specific use design.

One or more of the Frame Leg 13's may be a pipe or tube to provide a conduit for hydraulic/pneumatic, electrical, or instrumentation access the axis of the Mechanical Rotor invention.

Four Hinge Shaft 5's shown symmetrically, are attached between Wheel Plate 2's using a Roller Bearing 8 at each end.

Foil 4a, Foil 4b, Foil 4c and Foil 4d. Foil 4a and Foil 4b are solidly attached to each Hinge Shaft 5 and acted upon by the Linear Force 1 drag pressure. Foil 4c and Foil 4d are in the return position between the 180 degree and the 360 degree portion of a rotation. Foil 4c movement on Hinge Shaft 5 is illustrated by Foil Swing 15a arc. Three or more Hinge Shaft 5's, each with a Foil 4 is required by the Mechanical Rotor invention.

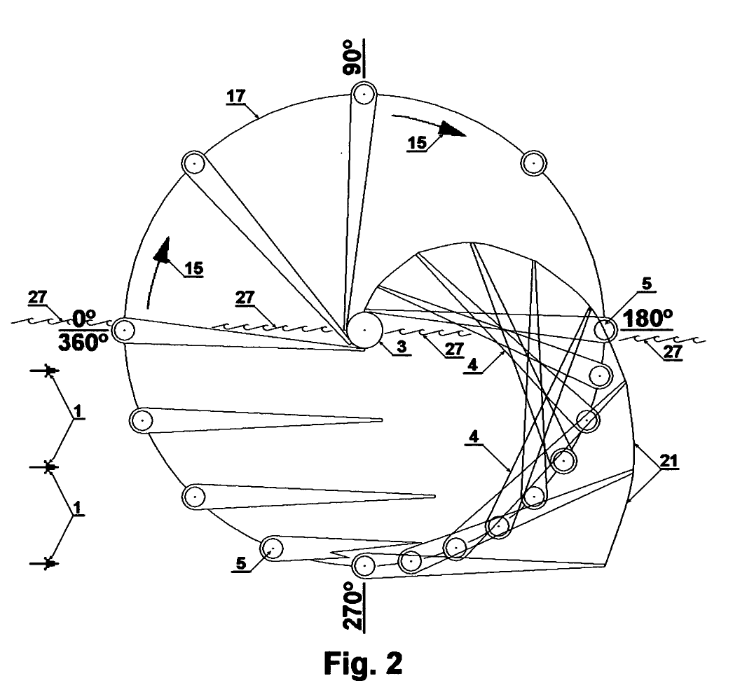

FIG. 2 represents the Mechanical Rotor invention in a horizontal axis position, perpendicular to the Linear Force 1 pressure of Flowing Water 27. Two of the four Foil 4's are shown submerged in Flowing Water 27 to the axel Power Shaft 3 and fabricated to move in a clockwise Rotation Direction 15.

The portion of the Mechanical Rotor above the Flowing Water 27 is exposed to natural air conditions, but for FIG. 2 illustration purpose, the linear force of any wind is ignored because of the approximately 800 times energy differential between equal velocities of flowing water and blowing wind.

Beginning at the 0 degree point of rotation, the Linear Force 1 exerts a positive drag on Foil 4, causing a clockwise Rotation Direction 15. As Foil 4 proceeds through the 45, 90, and 135 degree points until reaching the 180 degree point.

The Linear Force 1, passing the submerged side of Power Shaft 3, applies pressure on the submerged side of Foil 4 facing the 270 degree point of rotation. The Linear Force 1 continues exerting pressure at each position of a Foil 4 as illustrated by the overlay at each 11.5 degree point of the Hinge Shaft 5 during rotation between 180 degrees and the 270 degree points. The overlaying plot also shows the Foil Tip Path 21 during the swing on Hinge Shaft 5.

The overlay plotting of FIG. 2 demonstrates how the Linear Force 1 applies pressure on the Foil 4, causing a pressure to be applied on Hinge Shaft 5 which then relays a force onto Power Shaft 3, causing the Mechanical Rotor invention to develop Torque during Foil 4 swing to be aligned to be positioned at the 0 degree point of rotation.

During the rotation between 270 degree to the 360 degree point, Foil 4 has a negative leading edge drag across the Hinge Shaft 5 diameter but also may have a positive aerodynamic lift of Foil 4 aerodynamic shape.

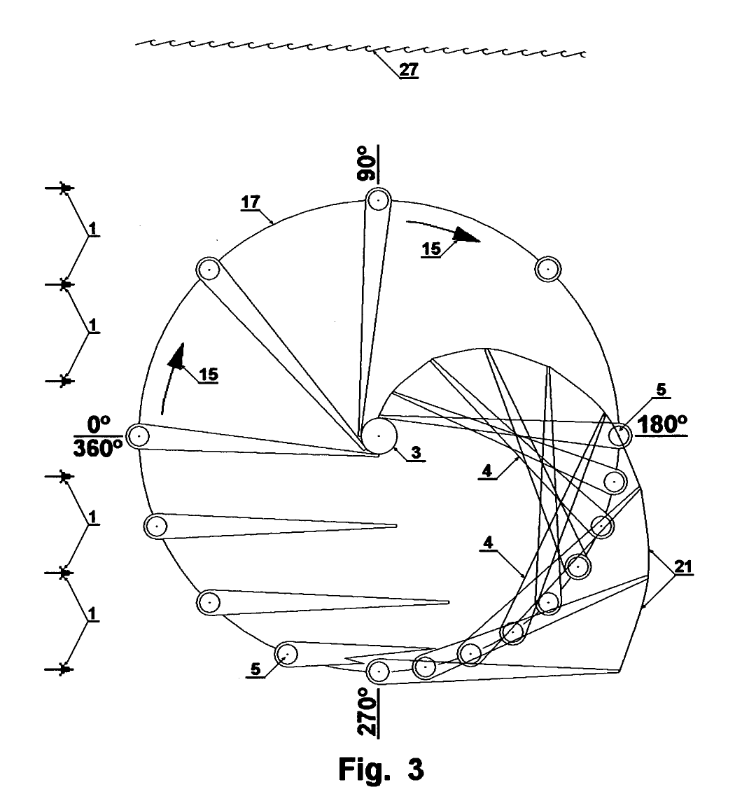

FIG. 3 represents a Mechanical Rotor invention in a horizontal axis position, perpendicular to the Linear Force 1 pressures of Flowing Water 27. The four Foil 4's are shown to be totally submerged into the Flowing Water 27, and fabricated to move in a clockwise Rotation Direction 15. The view is applicable to a mirrored view or as either clockwise or counter clockwise Rotation Direction 15.

FIG. 3 represents the locations of a Foil 4 acted upon by the Linear Force 1 during a single rotation of the Mechanical Rotor invention. During the rotation, the Hinge Shaft 5 follows a circle represented by Foil Hinge Shaft Path 17.

Beginning at 0 degree, the Linear Force 1 exerts a positive drag force pressure on Foil 4, causing a clockwise Rotation Direction 15. The Linear Force 1 continues applying pressure as Foil 4 proceeds through 45, 90, and 135 degree points, until reaching the 180 degree point of the rotation.

The Linear Force 1, passing the submerged side of Power Shaft 3, applies pressure on the submerged side of Foil 4, between Power Shaft 3 and the Hinge Shaft 5 for Foil 4. Each position of a Foil 4 is illustrated by an overlay of each 11.5 degree segment of the rotation between 180 degrees and the 270 degree point of rotation. The overlaying plot shows the Foil Tip Path 21 during the swing on Hinge Shaft 5.

The over lay during rotation from 180 degrees to 270 degrees points, allows the Linear Force 1 to apply pressure on the leeward side of Foil 4, causing a pressure to be applied on Hinge Shaft 5 which then is relayed onto Power Shaft 3, causing the Mechanical Rotor invention to develop Torque.

Foil 4 continuing between the 270 degree rotation point to the 360 degree point of rotation, the Foil 4 is a natural directional vane, causing the invention to be constantly aligned toward Linear Energy 1.

During the 270 degree rotation point to the 360 degree point of rotation, Foil 4 will have a negative leading edge drag across Hinge Shaft 5 diameter and a positive aerodynamic lift force, because of the aerodynamic shape of Foil 4.

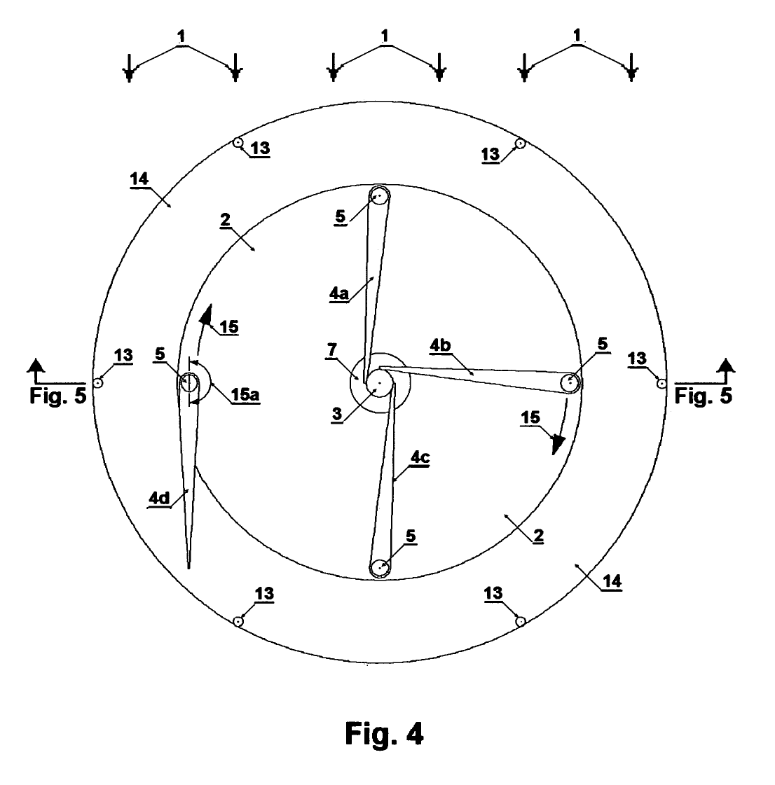

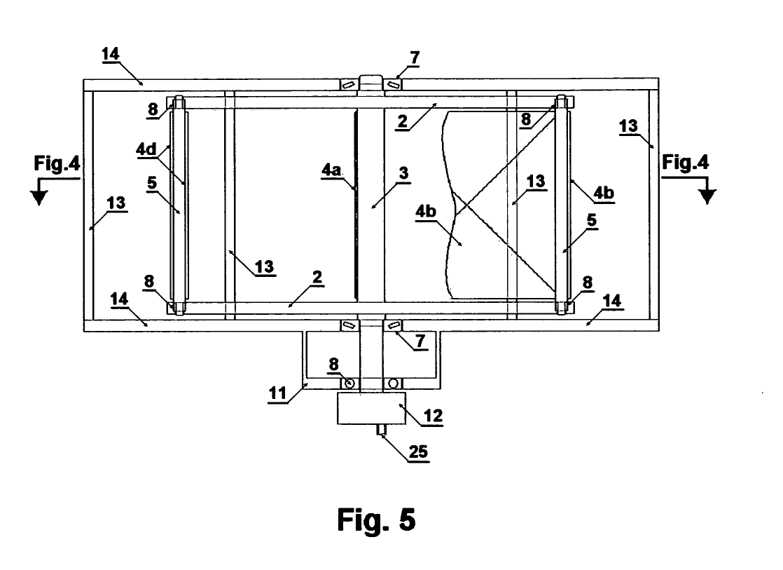

FIG. 4 is a circumferential section Plan view of the Mechanical Rotor invention. Sectional arrow direct reference view of the axial Elevation displayed at FIG. 5. The FIG. 4 drawing orientation aligns into Linear Force 1 housed in a cage open to 360 degree of a varying Linear Force 1 pressure.

FIG. 4 shows six symmetrically located Frame Leg 13's around Support Plate 14. Two or more Frame Leg 13's are required for stable structural fabrication. Support Plate 14 is sized to accommodate the symmetrically located Frame Leg 13's being clear of any contact by the swing of a Foil 4 on Hinge Shaft 5, no matter what direction Linear Force 1 may be traveling.

FIG. 4 displays Thrust Bearing 7 in Support Plate 14 accommodating Power Shaft 3 which is solidly connected to Wheel Plate 2 forming a part of the Mechanical Rotor's spool shape containing Foil 4's. Displayed by FIG. 4 are Foil 4a, Foil 4b, Foil 4c and Foil 4d, symmetrically oriented around Wheel Plate 2 in a clockwise Rotation Direction 15 with each connected to a Hinge Shaft 5.

Foil 4a is located at the 0 degree point of a rotation of the Mechanical Rotor invention. Foil 4b is at the 90 degree point of rotation and receives maximum pressure from Linear Force 1. Foil 4c is at the 180 degree point of rotation, ending exposure to the pressure from Linear Force 1 on the windward side and beginning receiving pressure from Linear Force 1 on the leeward side.

Foil 4d is shown with Foil 4d's Hinge Shaft 5 being the leading edge for return from the 270 degree point of rotation to the 0 degree point of rotation. During rotation from the 180 degree to the 270 degree point of rotation, Foil 4d made a Foil swing 15a of 180 degrees on the Hinge Shall 5. During the time period amassing Foil swing 15a, Foil 4d exerted a measurable pressure on Hinge Shaft 5 which relayed a measurable amount of torque pressure to Power Shaft 3 via Wheel Plate 2.

FIG. 5 is an axial view of the Mechanical Rotor invention displayed in a vertical position. Section arrows direct reference view of FIG. 4 circumferential section Plan.

FIG. 5 shows Support apparatus 11, perhaps a part of a tower, a submergible, or when inverted, as an attachment to a rail, etc. The Support apparatus 11 is solidly attached to Support Plate 14 making a solidly attached to a second Support Plate 14. The Support Plate 14's are held apart by Frame Leg 13's, forming a functionally 360 degree open cage for exposure of the Mechanical Rotor Invention to all erratic directions of Linear Force 1.

Each Support Plate 14's house a Thrust Bearing 7 to facilitate Power Shaft 3 rotation. Also shown is a Roller Bearing housed by Support apparatus 11 to stabilize and facilitate Power Shaft 3 rotation. Solidly attached to Power Shaft 3 is two Wheel Plate 2's forming a spool shape, separated by the Hinge Shaft 5's mounted at each end into Roller Bearings 8 housed by the Support Plate 14's.

FIG. 5 exposes the tip end of Foil 4a on the leeward side of Power Shaft 3 when at the 0 degree point of a rotation. On the windward side of Power Shaft 3 is Foil 4b exposed leeward side as attached to hinge shaft 5 at the 90 degree point of rotation. The viewable section of Foil 4c is exposed at the Hinge Shaft 5 when at the 270 degree point of rotation.

Attached to Power Shaft 3 is Torque Consumer 12, a hydraulic or pneumatic pump/motor, electric generator, pulley, gearing, break, etc., to accommodate specific desired design function. Umbilical Line 25 is shown to represent any method of conveying any substance such as hydraulic, pneumatic, electricity, instrumentation controls, a mechanical arm, etc. to a convenient point of physical use purpose.

Changing the axis length the Mechanical Rotor invention as shown by FIG. 5 will proportionally change the torque developed from Linear Force 1.

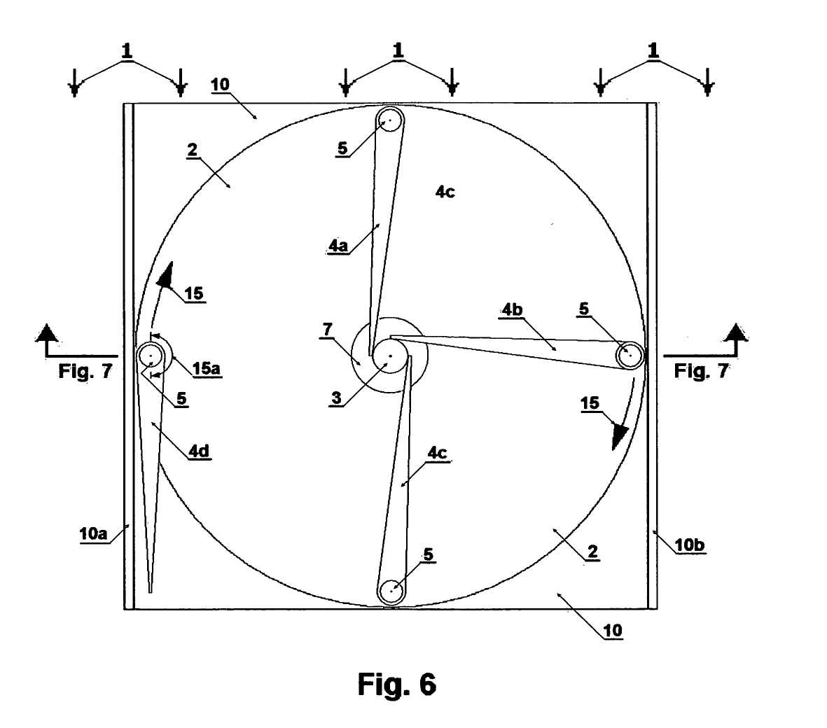

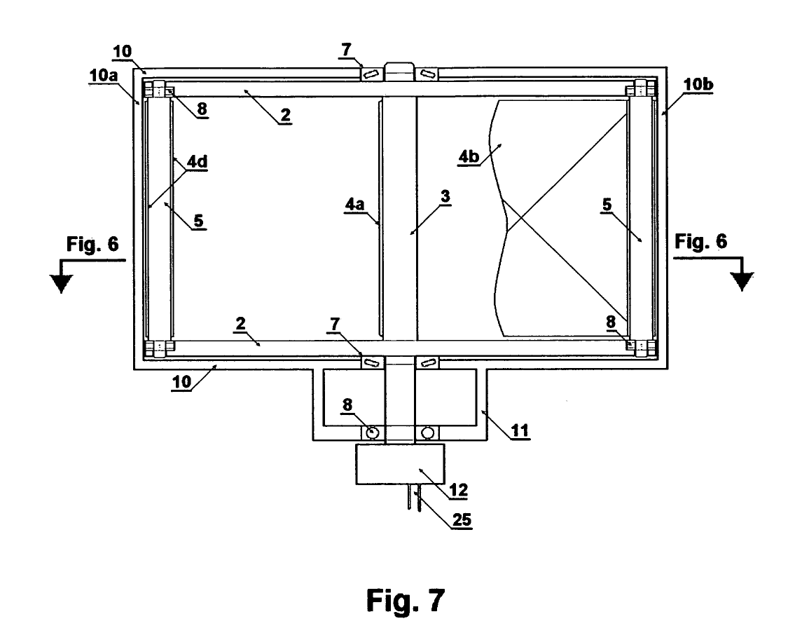

FIG. 6 is a circumferential section Plan view of the Mechanical Rotor invention. Sectional arrow direct reference view of the axial Elevation displayed at FIG. 5. The FIG. 4 drawing orientation aligns into Linear Force 1 while housed in a rectangular duct. The rectangular duct may be open to receive Linear Force 1 from either direction or as directed by a duct or circular pipe transitioning into the rectangular duct.

FIG. 6 shows Duct Support 10a solidly attached to Duct Plate 10 on the leeward side of the Mechanical Rotor invention. The Duct Support 10b is solidly attached to Duct Plate 10 on the windward side of the Mechanical Rotor invention. Duct Support 10a and Duct Support 10b are parallel with minimal non-touching clearance on each side of Wheel Plate 2 circumference.

FIG. 6 displays Thrust Bearing 7 housed in Support Plate 10 accommodating Power Shaft 3 which is solidly connected to Wheel Plate 2 forming a part of the Mechanical Rotor's spool shape containing Foil 4's. Displayed by FIG. 6 are Foil 4a, Foil 4b, Foil 4c and Foil 4d, symmetrically oriented around Wheel Plate 2 in a clockwise Rotation Direction 15 with each connected to a Hinge Shaft 5.

FIG. 6 shows Foil 4a located at the 0 degree point of a rotation of the Mechanical Rotor invention, Foil 4b is at the 90 degree point of rotation and receives maximum pressure from Linear Force 1. FIG. 5 shows Foil 4c at the 180 degree point of rotation, ending exposure to the pressure from Linear Force 1 on the windward side and beginning receiving pressure from Linear Force 1 on the leeward side. Foil 4d is shown with Foil 4d's Hinge Shaft 5 being the leading edge for return from the 270 degree point of rotation to the 0 degree point of rotation.

During rotation from the 180 degree to the 270 degree point of rotation, Foil 4d made a Foil swing 15a of 180 degrees on the Hinge Shaft 5. During the time period amassing Foil swing 15a, Foil 4d exerts a measurable pressure on Hinge Shaft 5 which relays a measurable amount of torque pressure to Power Shaft 3 via Wheel Plate 2.

FIG. 7 is an axial view of the Mechanical Rotor invention displayed in a vertical position. Sectional arrow directs reference view of FIG. 6 circumferential section Plan.

FIG. 7 shows Support apparatus 11, perhaps a part of a tower, a submergible, or inverted attachment to a raft, etc., being solidly attached to Support Plate 10 which is solidly attached to a second Support Plate 10 held separate by Leeward Duct Support 10a and Windward Duct Support 10b, forming a rectangular duct around the Mechanical Rotor Invention. A Duct limits the Linear Force 1 pressure to bi-direction exposure on the Mechanical Rotor Invention.

Each Support Plate 10's house a Thrust Bearing 7 to facilitate Power Shaft 3 rotation. Also shown is a Roller Bearing housed by Support apparatus 11 to stabilize and facilitate Power Shaft 3 rotation. Solidly attached to Power Shaft 3 is two Wheel Plate 2's forming a spool shape, separated by the Hinge Shaft 5's mounted at each end into Roller Bearings 8 housed by the Support Plate 10's.

FIG. 7 exposes the tip end of Foil 4a on the leeward side of Power Shaft 3 when at the 0 degree point of a rotation. On the windward side is Foil 4b exposed leeward side as attached to hinge shaft 5 at the 90 degree point of rotation. The viewable section of Foil 4c is exposed at the Hinge Shaft 5 when at the 270 degree point of rotation.

Attached to Power Shaft 3 is Torque Consumer 12, a hydraulic or pneumatic pump/motor, electric generator, pulley, gearing, break, etc., to accommodate specific desired design function. Umbilical Line 25 is shown to represent any method of conveying any substance such as hydraulic, pneumatic, electricity, instrumentation controls, a mechanical arm, etc. to a convenient point of physical use purpose.

The rectangular duct formed by Duct Support 10a, Duct Support 10b, and the two Duct Plate 10's, will limit the exposure of the Mechanical Rotor invention to Linear Force 1 to two directions. Delivery of Linear Force 1 may be natural open exposure or from piped conveyance to either open end of the rectangular duct housing the Mechanical Rotor invention. A pre-selected Rotation Direction 15 of the Mechanical Rotor invention will remain the same with Linear Force 1 pressure applied at either open end of the rectangular duct.

Changing the axis length the Mechanical Rotor invention as shown by FIG. 7, will proportionally change the torque developed from Linear Force 1.

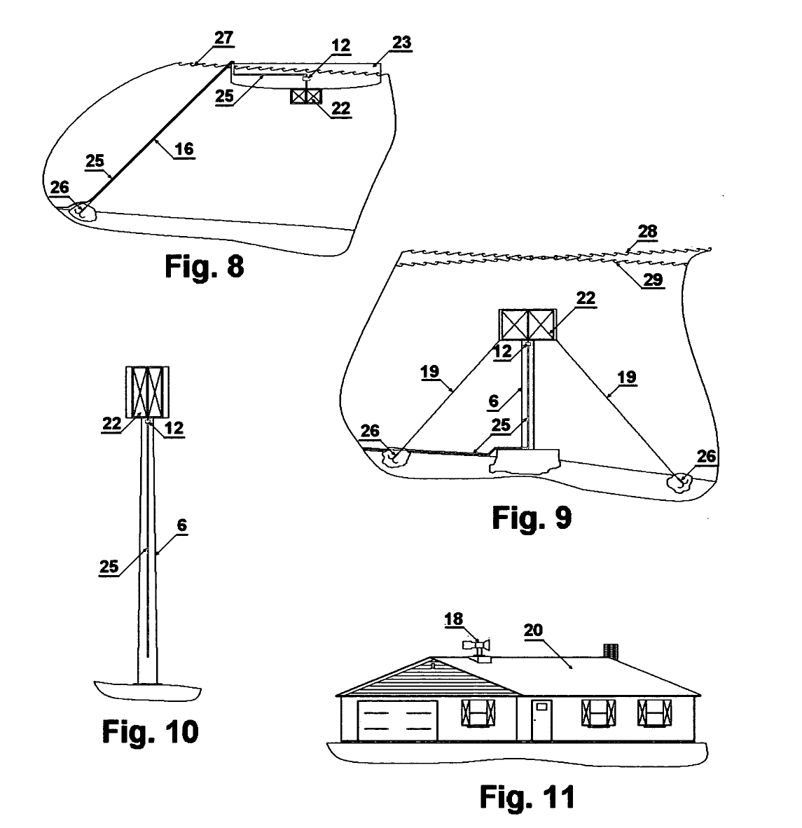

FIG. 8 shows a Mechanical Rotor 22 invention being buoyed by Raft, Float, Barge, Ship, etc. 23, in Flowing Water 27. The Float, Barge, Ship, etc. 23 is held functionally stationary by Anchor Chain 16 attached to Anchor 26 at the stream bed.

The Raft, Float Barge, Ship 23 allows for the Torque Consumer 12 to be accessible in dry conditions above the Flowing Water Surface 27.

Umbilical Line 25 in the Raft, Float, Barge, Ship, etc. 23 connects to the Flexible Umbilical Line 24 which is tied to Anchor Chain 16 to provide a conduit for transmission of hydraulics, pneumatics, electricity, or instrumentation, etc. to desirable points of convenience. The Umbilical Line 25 could be via pole supported overhead erection where applicable to a specific location.

FIG. 9 illustrates a Support Tower 11, supporting an open cage Mechanical Rotor 22 invention or a rectangular duct Mechanical Rotor 22, under the water of a Neap Tide 28 and opposing Ebb Tide 29 location. Connected to Mechanical Rotor 22 is moisture free Torque Consumer 12, a hydraulic or pneumatic pump/motor, electric generator, pulley, gearing, brake, etc., to accommodate specific desired design function.

Anchor Guy 19's are displayed to show possibilities when necessary, dependant upon the structural ability of Support Tower 6. Each Anchor Guy 19's are displayed connected to Anchor 26.

Umbilical Line 25 is displayed to indicate a conduit routing of transmission of hydraulics, pneumatics, electricity, or instrumentation, etc. to desirable points of convenience.

FIG. 10 represents a free standing Support Tower 11, supporting a Mechanical Rotor Configuration 22. The Mechanical Rotor Configuration 22 is shown connected to weather protected Torque Using Device 12, a hydraulic or pneumatic pump/motor, electric generator, pulley, gearing, break, etc., to accommodate specific desired design function.

FIG. 11 demonstrates a small size Mechanical Rotor Configuration 22 in a rectangular duct. Vane Shroud 18 is a Mechanical Rotor invention in a rectangular duct adapted with a square funnel inlet and a wind directional vain and placed on a structurally sound Roof 24.

The simple unique invention herein described is fully actuated by the moving forces of the substance applying linear forces without the aid of springs, special stops.

The information about the invention described herein demonstrates a uniquely simple method of gathering usable energy from flowing rivers, streams, ocean tides without constructing dams or special flow directing canals.

Although the invention herein has been described with respect to exemplary embodiments thereof, it will be understood that variations and modifications can be affected in these embodiments without departing from the scope or spirit of the invention.

1. A novel mechanical rotor uniquely adapted with three or more foils that salvage for useful purposes, torque energy from the excess linear kinetic forces produced by flowing rivers, streams, ocean currents, blowing wind or other moving fluid substances without constructing dams or special flow directing canals.

2. A novel mechanical rotor, in a vertical axis or horizontal axis position, can be partially or totally submerged in a linear kinetic moving substance to capture torque energy.

3. The novel mechanical rotor is a simple device, scalable diametrical or axial, stacked or cluster grouped for production and design engineered for a structurally sound apparatus needed to withstanding the linear force of rapid flowing rivers, streams, ocean currents or irregular gusting gale force winds.

4. The novel mechanical rotor can be installed in an open stationary cage for device exposure to erratic 360 degree direction of linear kinetic force or installed in an open end rectangular duct for the invented device to be exposed to linear kinetic force at the open ends of the duct.

5. A novel mechanical rotor installed in a rectangular duct may be a part of a duct or piping transporting system moving a fluid or gaseous substance having an excess of linear kinetic force available for being salvaged for useful purposes.
